(19) United States
(12) Patent Application Publication
(10) Pub. No.: US 2023/0287981 A1
(43) Pub. Date: Sep. 14, 2023

(54) Directional Control Valve

(71) Applicant: Milwaukee Electric Tool Corporation, Brookfield, WI (US)

(72) Inventors: Timothy Radtke, New Berlin, WI (US); Mauricio Uruena, Brookfield, WI (US)

(21) Appl. No.: 18/182,978

(22) Filed: Mar. 13, 2023

Related U.S. Application Data
(60) Provisional application No. 63/319,134, filed on Mar. 11, 2022.

(51) Int. Cl. F16K 11/074; F16K 37/00; F16K 31/04; F15B 15/18; F15B 13/02

(52) U.S. Cl. CPC F16K 11/0743; F16K 37/0041; F16K 31/043; F15B 15/18; F15B 13/02; F15B 2211/30

(57) ABSTRACT

A directional control valve for a dual action hydraulic pump is provided. The directional control valve can include a valve body comprising four ports and a rotor positioned within the valve body and comprising a plurality of passages configured to connect and disconnect the ports of the valve body. The directional control valve can also include a plurality of shear seal discs, each positioned adjacent to one of the plurality of passages, a sensor, and a motor configured to adjust a position of the rotor. The motor can be a brushless motor or a stepper motor.

### BACKGROUND

Hydraulic tools and pumps can include one or more directional control valves to connect and disconnect parts of a hydraulic circuit. Many current valves are solenoid-actuated valves, which require power to be on to maintain a position of the valve.

### SUMMARY

Embodiments of the invention provide a directional control valve for a dual action hydraulic pump. The directional control valve can include a valve body comprising four ports and a rotor positioned within the valve body and comprising a plurality of passages configured to connect and disconnect the ports of the valve body. The directional control valve can also include a plurality of shear seal discs, each positioned adjacent to one of the plurality of passages, a sensor, and a motor configured to adjust a position of the rotor. The motor can be a brushless motor or a stepper motor.

Some embodiments of the invention provide a method of operating a directional control valve including a valve body, a rotor positioned within the valve body, a plurality of shear seal discs, a sensor, a plurality of gear trains, and a motor configured to adjust a position of the rotor. The method includes activating the valve body with the plurality of gear trains and the motor, the motor coupled to the plurality of gear trains, and controlling a position of the valve body via at least one of the sensor and the motor, the motor being one of a brushless motor or a stepper motor.

Another embodiment of the invention provides a method of determining a valve position of a directional control valve including a valve body, a rotor positioned within the valve body, a sensor, a motor configured to adjust a position of the rotor, and a controller. The method includes depressing one of a plurality of buttons for an user designated valve position, determining if the valve is at the valve position via the controller, and sending a signal via the controller to activate the motor, the motor being one of a stepper motor or a brushless motor.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of a dual action hydraulic pump for use in some embodiments.

FIG. 2 is an isometric view of a hydraulic tool for use in some embodiments.

FIG. 3 shows a rotor for a directional control valve, according to some embodiments, in different positions.

FIG. 4 shows additional views of the rotor of FIG. 3.

FIG. 5 is an isometric view of a directional control valve according to some embodiments.

FIG. 6 is an isometric view of a rotor of the directional control valve of FIG. 5.

FIG. 7 are additional views of portions of the directional control valve of FIG. 5.

FIG. 8 are additional views of the directional control valve of FIG. 5 with different rotor positions.

FIG. 9 illustrates a directional control valve, according to some embodiments, in a first configuration.

FIG. 10 illustrates a directional control valve, according to some embodiments, in a second configuration.

FIG. 11 illustrates additional views of the directional control valve of FIG. 9

FIG. 12 illustrates additional views of the directional control valve of FIG. 9

FIG. 13 illustrates additional views of the directional control valve of FIG. 10.

FIGS. 14 and 15 are flowcharts of a process of stepper motor operation of the directional control valve of some embodiments.

FIGS. 16, 17, 18, and 19 are flow charts of a process of brushless DC motor control operation, with discrete hall sensing, of the directional control valve of some embodiments.

FIGS. 20, 21, and 22 are flow charts of a process of brushless DC motor control operation, with ZMID sensing, of the directional control valve of some embodiments.

### DETAILED DESCRIPTION

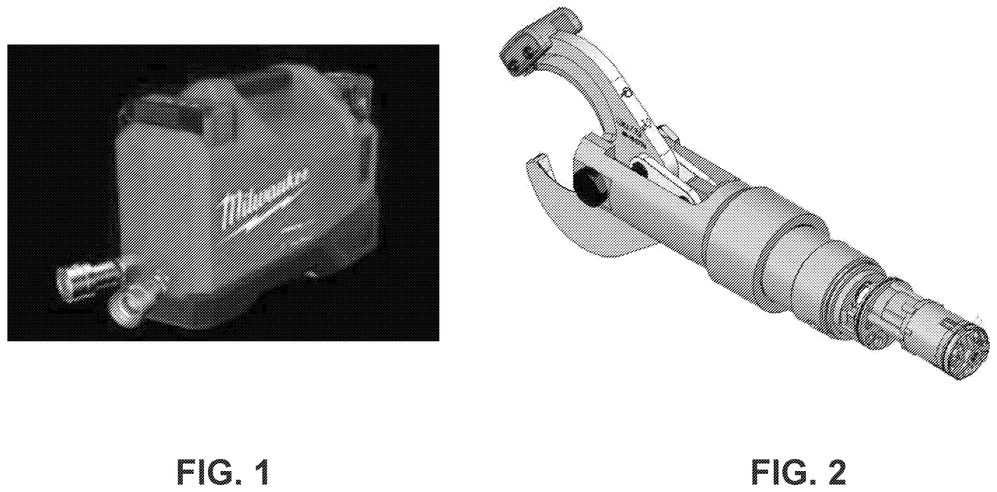

Some embodiments provide a directional control valve and, more specifically, an electrically operated rotary shear valve. The valve can be incorporated into a hydraulic pump, such as a dual action hydraulic pump, illustrated in FIG. 1, or a hydraulic tool, such as a battery operated cutter tool, illustrated in FIG. 2, or other hydraulic tools.

FIG. 2 illustrates a hydraulic tool, for example, configured as a cutter having a cutting head. In other embodiments, the hydraulic tool can include additional or alternative crimping or cutting features near the cutting head. For example, in some embodiments, the hydraulic tool can be configured as a crimper. The hydraulic tool includes a rotary drive system having a sprocket to drive a rotary valve. In some embodiments, the rotary valve is configured as a four-way rotary shear seal valve and includes a shear disc. The rotary drive system is at least partially housed by a load cylinder proximate to a gear case of a motor. In use, a high pressure piston pump can supply hydraulic fluid through the hydraulic circuit of the hydraulic tool to control the cutting head. In some embodiments, housed within the load cylinder, the hydraulic tool also includes a rapid advance inner cylinder, a high pressure relief valve, a low pressure relief valve, and a low pressure port to the rotary valve.

A directional control valve (DCV) is a device that controls the direction of fluid. More specifically, it can connect and disconnect parts of a hydraulic circuit. The valve of some embodiments can be a four-way and three-position rotary shear seal valve. Generally, the valve has a rotor that has a defined layout for port communications and, by rotating the rotor, the communication between the ports changes. Another characteristic is that the ports are sealed by shear seal discs that contact the rotor base, as shown below.

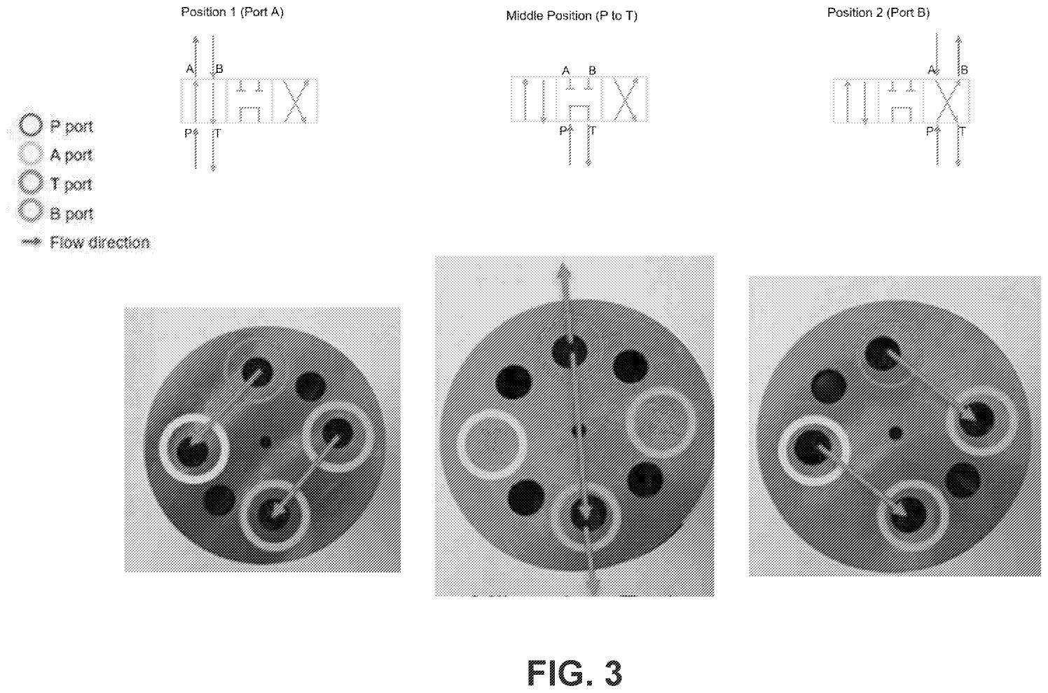

As shown in FIG. 3, a four-way, three-position valve has four ways or ports: Pressure Port P (P), Port A (A), Port B (B), and Tank Port T (T). The three positions include position 1 (Port A), middle position, and position 2 (Port B). The middle position may be considered the neutral position. When the rotor is shifted from neutral to the A or B position, fluid ports in the valve body will line up with the fluid ports in the rotor to allow fluid to flow to the proper port. More specifically, in position 1, Pressure is in communication with A port while B port is in communication with Tank. In the middle position, pressure is in communication with Tank while A and B ports are blocked (e.g., no flow). In position 2, Pressure is in communication to B port while A port is in communication with Tank.

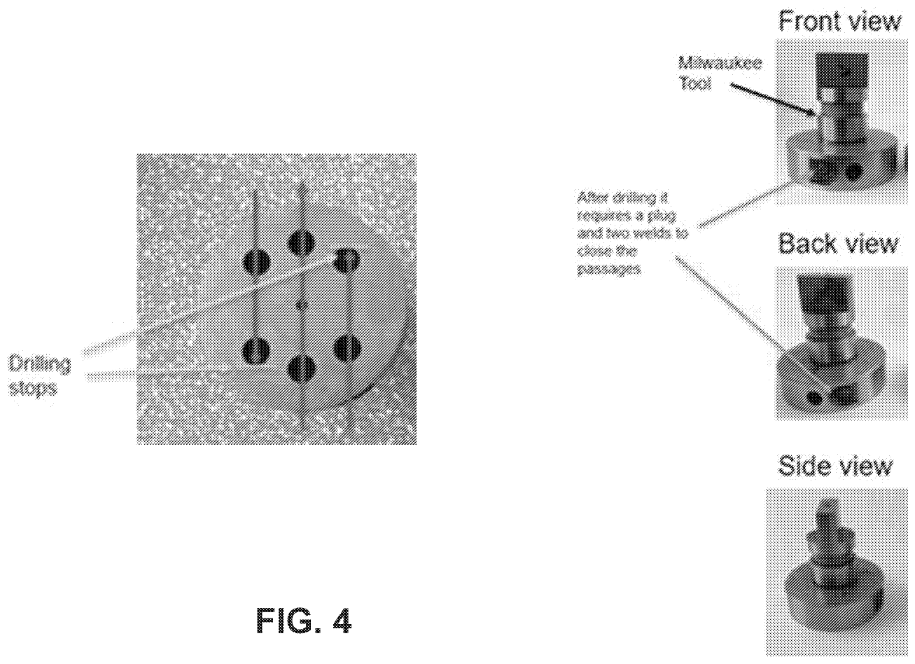

FIG. 4 illustrates additional views of a rotor of the valve, according to some embodiments. For example, the rotor can include drilled radially and axially extending passages connecting ports on the edge and side surfaces thereof. Some of the drilled passages can be closed at one end by welding or plugging.

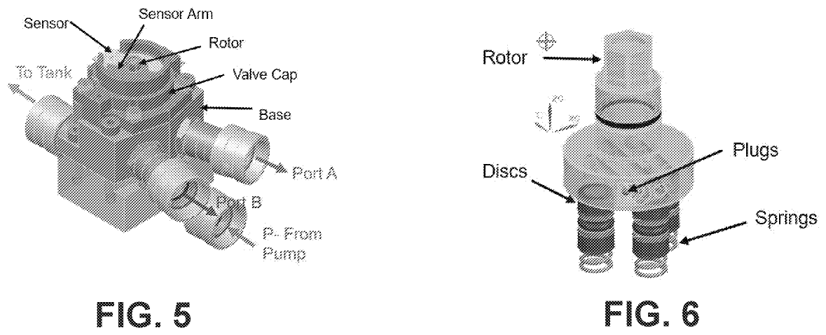

FIGS. 5 and 6 illustrate parts of the valve, including a valve body, a sensor, a sensor arm, a rotor, a valve cap, a base, plug, discs, and springs. The valve body can also be configured to further include a first and second pair of teeth. In general, the double tooth structure is configured to provide elevated angular rotation, specifically, increased angular rotation capabilities compared to rotary valves used in a two-position, two-way configuration having only singular teeth (e.g., not in a pair at the same axial position). FIG. 5 also shows the four ports (P, A, B, and T) of the valve body. The valve of some embodiments can be a four-way rotary shear seal valve.

As shown in FIG. 6, the valve of some embodiments may be configured as the rotary valve including three shear seal discs at one end of the valve body. In some cases, three shear seal discs can provide a high valve cycle lift, tight sealing, and positive load control. The three shear seal discs can correspond to and seal a first port A, a second port B, and a pressure port P of the rotary valve. The rotary valve can also include a tank port T. In some embodiments, the rotary valve is configured to be a part of a hydraulic system which also includes a load cylinder and a high-force load ram. The load ram can separate the load cylinder into a rod end and a cylinder end. An inner cylinder can extend through the cylinder end and can be used for rapid advancement of the load ram. The first port A is configured to be in fluid communication with the inner cylinder and is configured to be selectively in fluid communication with the cylinder end of the load cylinder. The second port B is configured to be in fluid communication with the rod end of the load cylinder. The pressure port P is configured to be in fluid communication with a high pressure pump and fluid reservoir. The tank port T is configured to be in fluid communication with a tank (e.g., reservoir).

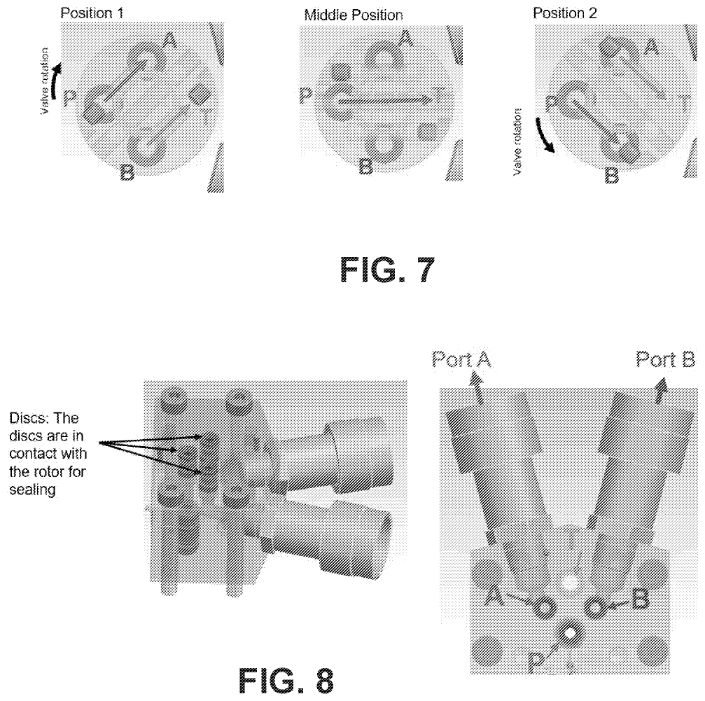

As shown in FIG. 7, the discs are in contact with the rotor for sealing. As shown in FIG. 8, when the valve rotates, it connects the cavities to direct the flow from pressure Port (P) to Port A or Port B, and A or B to tank port (T). In the middle position, flow from pump goes to tank Port T while Port A and B are closed.

In some embodiments, the valve is configured to be a part of a hydraulic system that can be used for rapid advance ram extension, high force ram extension (e.g., a higher force than a rapid ram extension), ram retraction, system overload protection at high pressure, low pressure protection at the rod end of the load cylinder, and system decompression. In particular, during rapid advance ram extension, the pressure Port P of the rotary valve of FIG. 8 can be in fluid communication with Port A. During such rapid advance ram extension, the Port A is in communication with the inner cylinder of the load cylinder to move the load ram within the load cylinder, and Port A is blocked from fluid communication to the cylinder end of load cylinder. Additionally, during each of a rapid advance ram extension and a high force ram extension, Port A is in fluid communication with the pressure Port P.

In some embodiments, during a ram retraction phase, the pressure Port A can be in fluid communication with the tank Port T to drain hydraulic fluid from the cylinder end of the load cylinder and the inner cylinder so that the load ram can retract. Additionally, during ram retraction, the pressure Port B is in fluid communication with the pressure port P so that high pressure fluid can be directed to the rod end of the load cylinder to retract the load ram. In some cases, the pressure Port P in fluid communication with pressure Port B provides hydraulic cylinder retraction and eliminates the need for a return spring.

In some embodiments, during a system overload protection from high pressure, a high-pressure relief valve that is pre-set above a system pressure can allow high pressure fluid to flow from the cylinder end to the rod end and out to a tank. Accordingly, during a system overload protection from high pressure, pressure Port B (which can be configured to connect to the rod end of the load cylinder) is in fluid communication with the tank Port T. The system overload protection may occur during a rapid advance ram extension or a high force ram extension.

In some embodiments, during a low pressure protection at the rod end of the load cylinder, a low pressure relief valve that is preset at a low pressure (e.g., 1000 psi) can allow fluid to flow from the rod end to the cylinder end and out to a tank. Accordingly, during a low pressure protection at the rod end of the load cylinder, pressure Port A (which can be configured to connect to the cylinder end of the load cylinder) is in fluid communication with the tank Port T. The low pressure protection may occur during ram retraction.

In some embodiments, system decompression can occur when pressure Port A is in communication with the pressure Port P and a manual release valve relieves pressure from a high pressure piston pump and a reservoir. Further, pressure Port B is in communication with the tank Port T during system decompression.

In general, embodiments of the rotary valve described herein can be configured to a hydraulic system to allow for double acting cylinder operation (i.e., extension and retraction) while providing pressure protection in both directions.

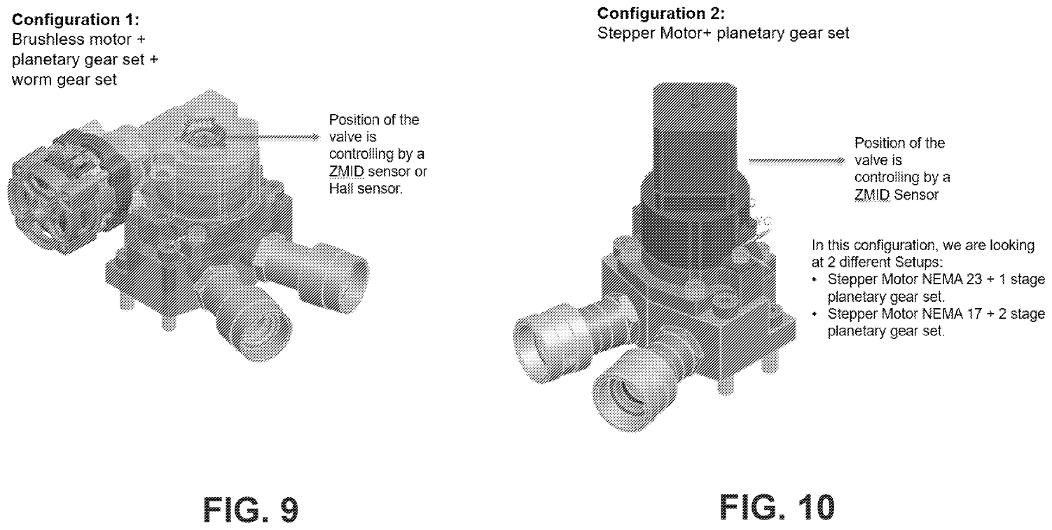

To move the valve between the three positions, two configurations are described below to activate the valve body using motors coupled with gear trains, according to some embodiments. FIG. 9 illustrates a first configuration, which includes a brushless motor (e.g., a brushless electric DC motor, or BLDC) and two gear trains (e.g., a planetary gear set, and a worm gear set). The position of the valve is controlled by, for example, a ZMID sensor or a Hall sensor. FIG. 10 illustrates a second configuration, which can include a stepper motor and single gear train (e.g., a planetary gear set). The position of the valve is controlled by, for example, a ZMID sensor and the motor steps. In this second configuration, there can be two different setups: (1) a stepper motor (NEMA 23) and single-stage planetary gear set; or (2) a stepper motor (NEMA 17) and two-stage planetary gear set. Generally, in some embodiments, the first configuration can permit a packing gear reduction compared to the second configuration. Also, in some embodiments, the second configuration can reduce the gear ratio for actuating the valve, and also make controlling valve position and accuracy easier compared to the first configuration. In either configuration, valve position can be maintained regardless of power being on (e.g., in comparison to solenoid-actuated valves, which require power to be on to maintain position of a valve).

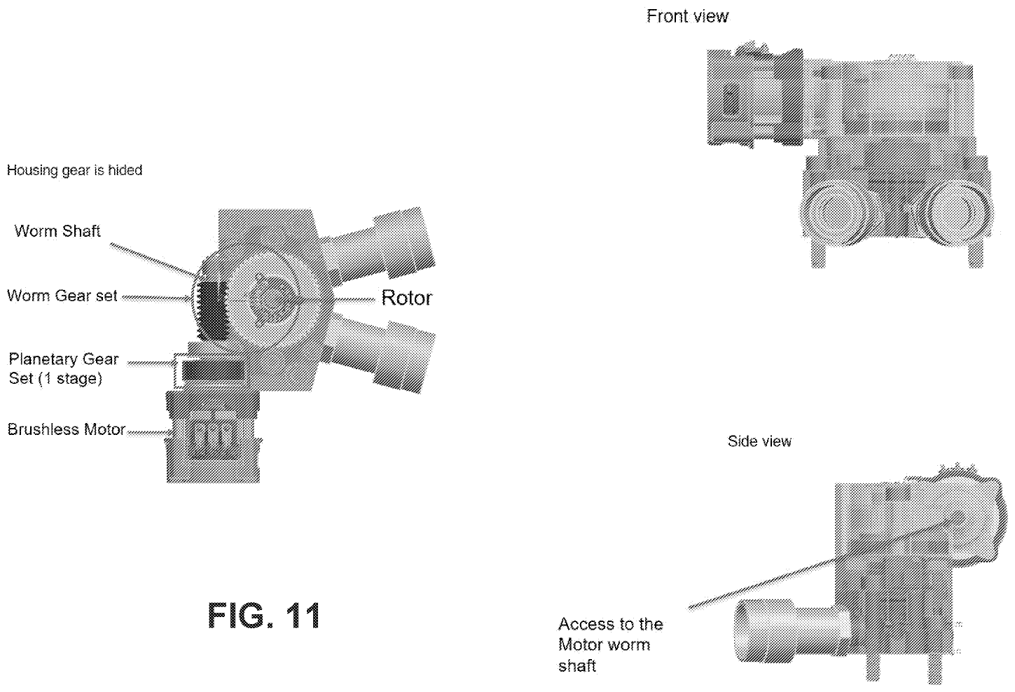

FIG. 11 illustrates further views of the first configuration (with the housing gear hidden). As noted above, this configuration uses a brushless motor coupled with a planetary gear set (1 stage) and a worm gear set for transmission. The parts of this configuration are above the valve cap, the shear seal discs, and the springs. A ZMID Sensor and/or hall sensing can be used to control the rotor position. The ZMID sensor can require a sensor arm that is coupled to the rotor, and the sensor board is located below it. Also, there can be an aperture in the top housing to get access to the worm shaft to actuate the valve manually, if it is needed (as shown in the side view).

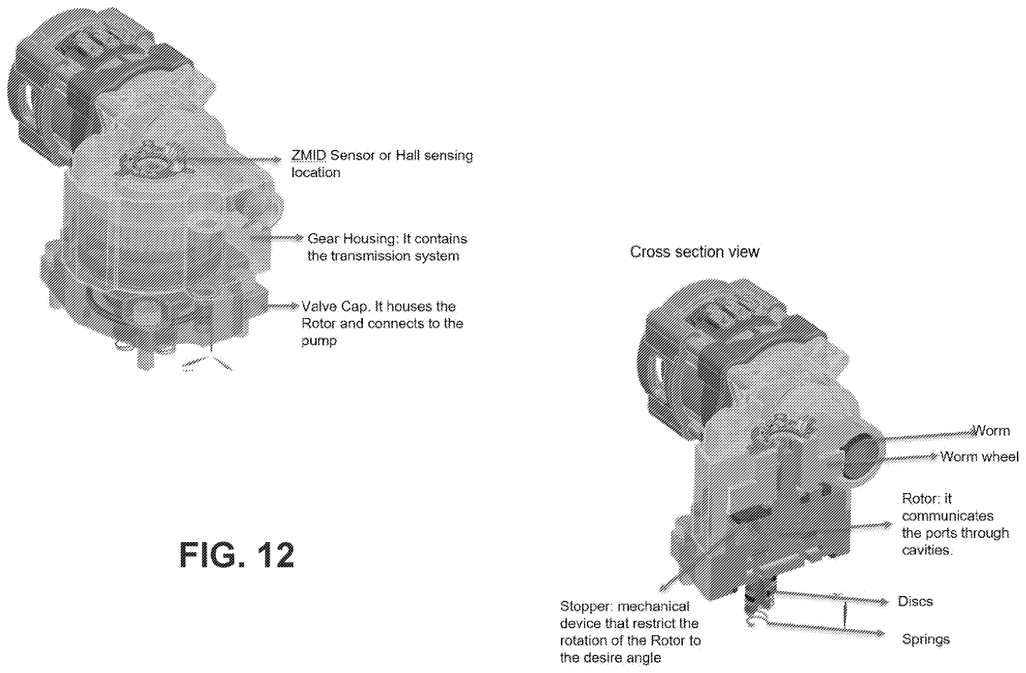

FIG. 12 illustrates further views of the first configuration. In particular, FIG. 12 illustrates the ZMID sensor or hall sensing location, the gear housing (which contains the transmission system), and the valve cap (which houses the rotor and connects to the pump). The cross-sectional view illustrates a worm, a worm wheel, the rotor (which communicates the ports through cavities), a stopper (which can be a mechanical device that restricts the rotation fo the rotor to a desired angle), the discs, and the springs.

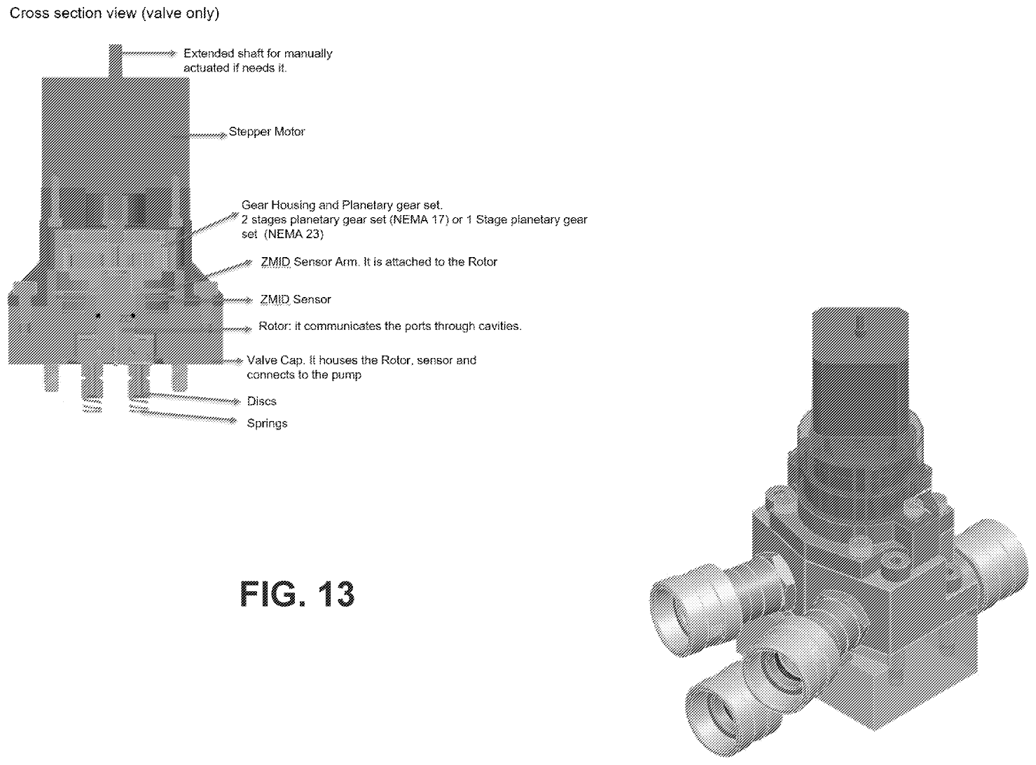

FIG. 13 illustrates further views of the second configuration. As noted above, this configuration uses a stepper motor coupled with a planetary gear set for transmission (one or two stages). The parts are above the valve Cap, the shear seal discs, and the springs. For position controlling of the rotor, a ZMID sensor can be used. The ZMID sensor can require a sensor arm that is coupled to the rotor, which is in fluid communication with the ports through cavities, and then the sensor board is located below it. Additionally, the motor shaft is extended so it can be actuated manually, if it is needed.

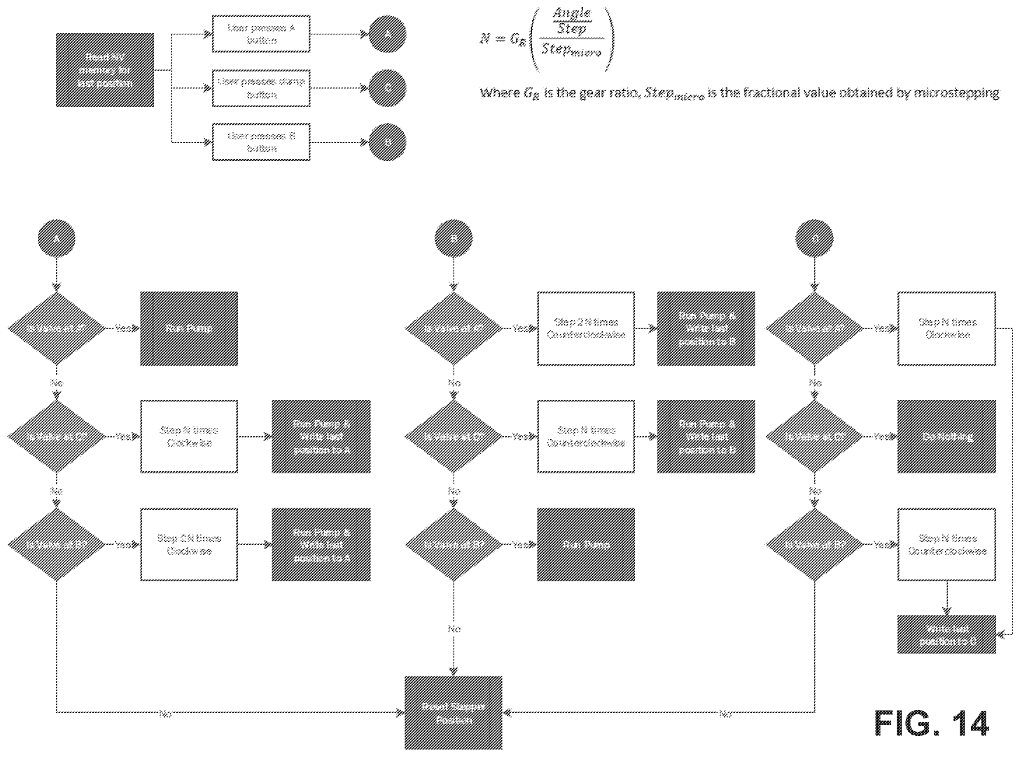

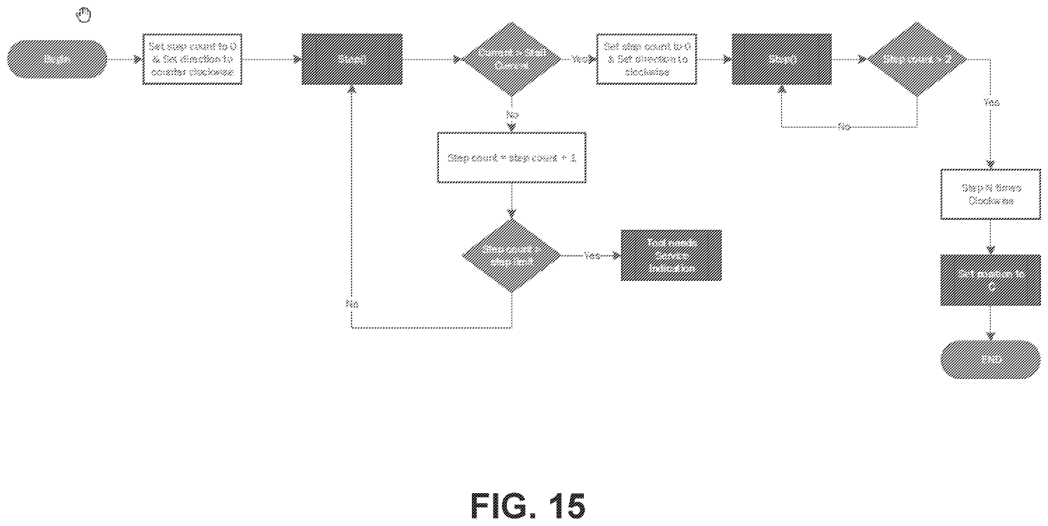

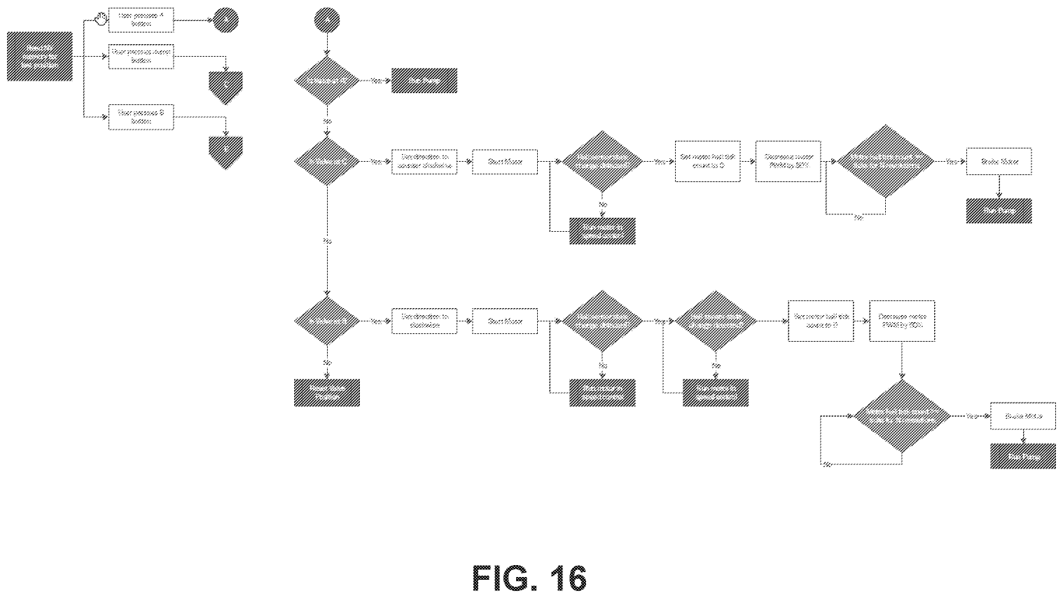

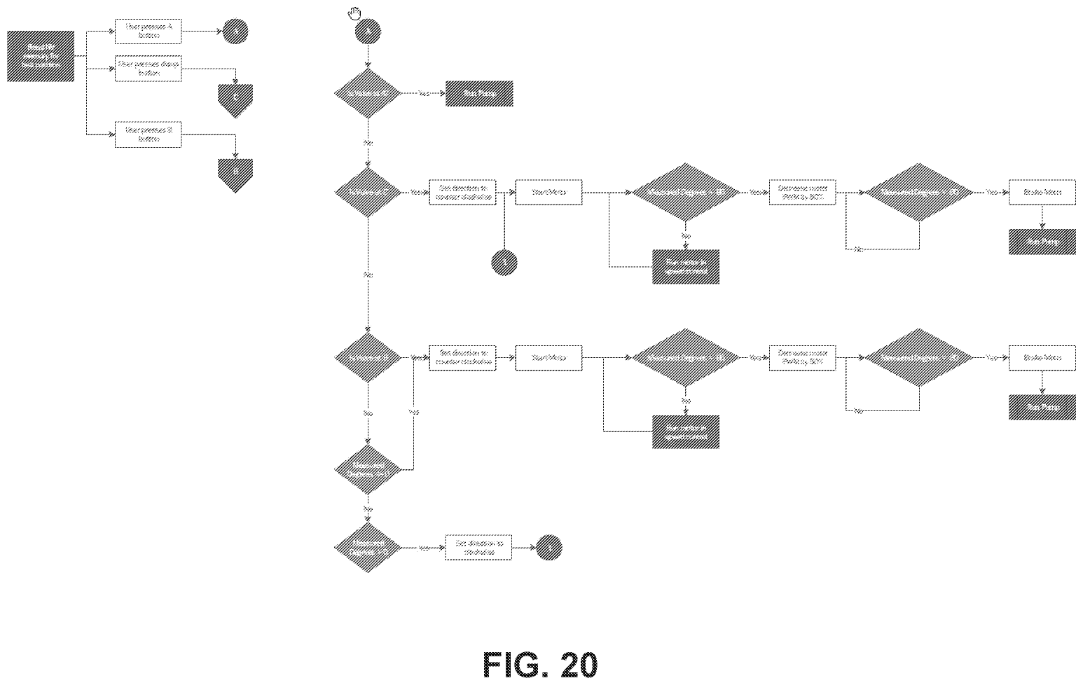

FIGS. 14-22 illustrate flow charts of operation methods. In particular, FIGS. 14 and 15 illustrate stepper motor control. FIGS. 16-19 illustrate BLDC motor control with discrete hall sensing for position. FIGS. 20-22 illustrate BLDC motor control with continuous angular measurements via ZMID sensing.

Referring now to stepper motor control (FIGS. 14 and 15), on the pump, a user can depress three buttons for operation: button A; button B; or button C. Button A relates to charge A: pressurized fluid to port A. Button C relates to dump pressure, that is, to relieve pressure and move the valve to the center position. Button B relates to charge port B. In some embodiments, in operation, the user can continue holding down the button for the pump to work.

Based on user selection, there are different methods to determine valve position. For example, if user depresses button A, operation follows flow from A in the flowchart of FIG. 14. If the valve is at A and there is pressurized fluid at pump A, then the pump can run. If the valve is not at position A, then the controller determines if the valve is at position C. If yes, then the controller sends a signal to move the valve clockwise (or counterclockwise) by N number times (where N is the number of steps of stepper to move to position A) and then run pump and write last position to A. N can be determined using the formula in FIG. 14. For example, in one embodiment, there is a 45 degree angle from position C to position A.

If the valve is not at position C, then processing continues to determine if valve is at position B. If yes, then the controller sends a signal to step the valve position 2N times in clockwise direction to get to position A and then run the pump and write last position to A. If the valve is not at any of positions A, B or C, then the stepper position is reset, as shown in FIG. 15.

Similar processing can be executed for user selection of position B as for position A described above. For example, if user depresses button B, operation follows flow from B in the flowchart of FIG. 14. If the valve is at A and there is pressurized fluid at pump A, then the controller sends a signal to step the valve position 2N times in counterclockwise direction to get to position B and then run the pump and write last position to B. If the valve is not at position A, then the controller determines if the valve is at position C. If yes, then the controller sends a signal to step the valve position N times in counterclockwise direction to get to position B and then run the pump and write last position to B. If the valve is not at position C, then the controller determines if the valve is at position B. If the valve is at position B and there is pressurized fluid at pump B, then the pump can run. If the valve is not at any of positions A, B or C, then the stepper position is reset, as shown in FIG. 15.

Similar processing can be executed for user selection of position C as for position A and B described above. For example, if user depresses button C, operation follows flow from C in the flowchart of FIG. 14. If the valve is at A and there is pressurized fluid at pump A, then the controller sends a signal to step the valve position N times in clockwise direction to get to position C and then run the pump and write last position to C. If the valve is not at position A, then the controller determines if the valve is at position C. If yes, then the controller sends a signal to do nothing. If the valve is not at position C, then the controller determines if the valve is at position B. If the valve is at position B and there is pressurized fluid at pump B, then the controller sends a signal to step the valve position N times in counterclockwise direction to get to position C and then run the pump and write last position to C. If the valve is not at any of positions A, B or C, then the stepper position is reset, as shown in FIG. 15.

If the valve is not at any of positions A, B or C, then the stepper position is reset, and the operation begins by setting the step count to 0 and the direction is set to counterclockwise. If the current is less than or equal to the stall current, then processing continues and the controller sends a signal to increase the step count by one. Operation then follows to determine whether the step count is greater than the step limit. If yes, then the controller sends a signal indicating that the tool needs service. If no, then the processing repeats until the current is greater than the stall current. Once the current is greater than the stall current, the operation continues by setting the step count to 0 and the direction is set to clockwise. If the step count is not greater than 2, then the controller sends a signal to increase the step count by one. Once the step count is greater than 2, the controller sends a signal to step the valve position N times in clockwise direction to get to position C and the stepper position reset process of FIG. 15 ends.

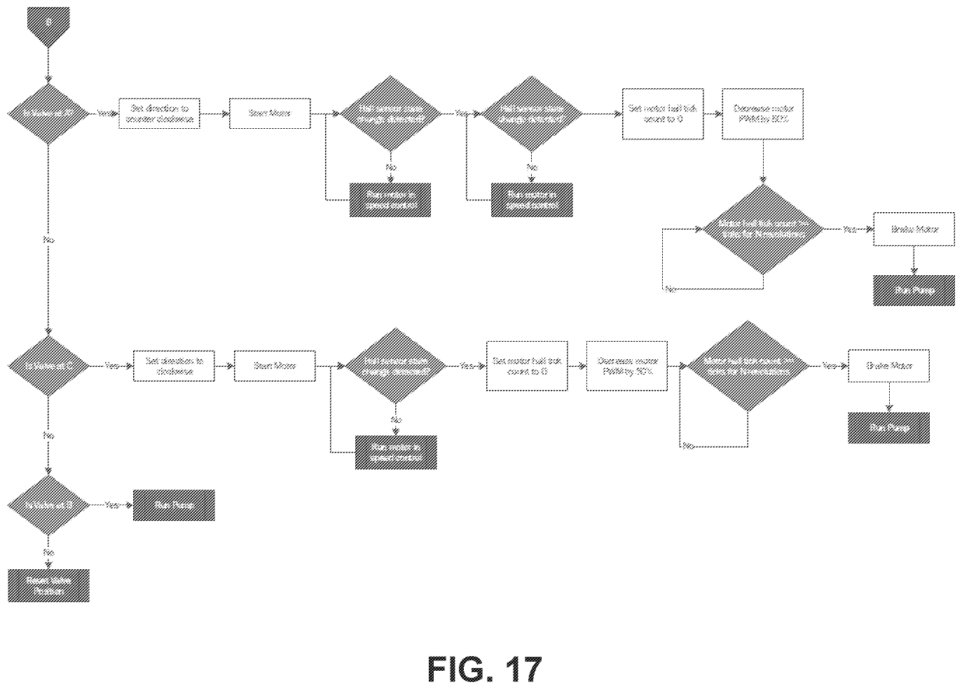

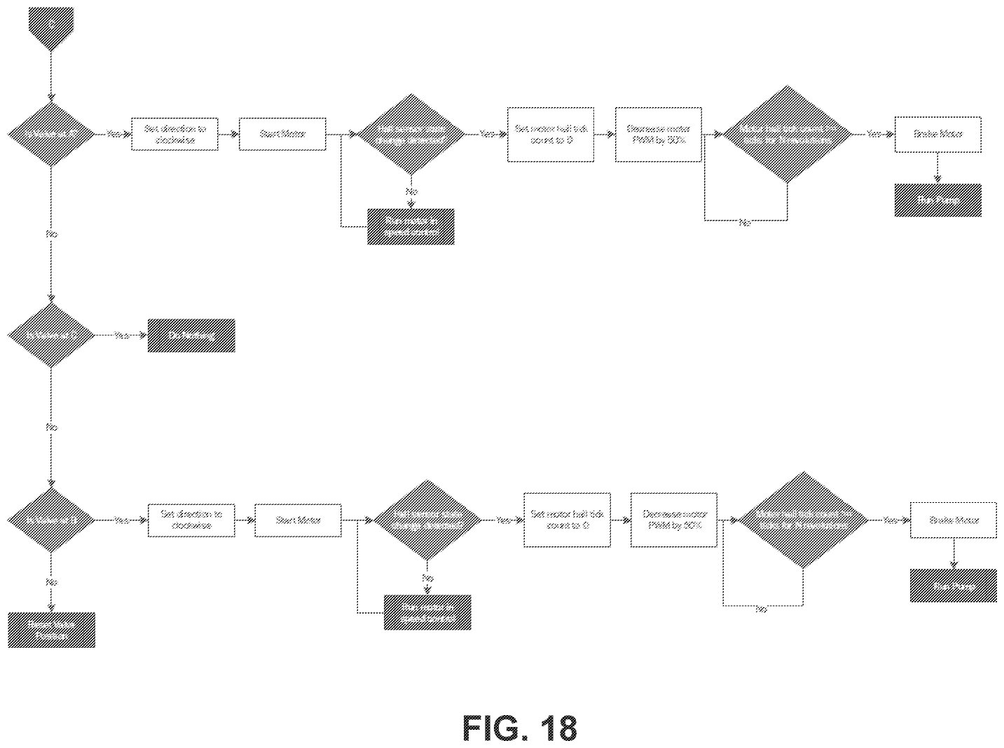

Referring now to BLDC motor control with discrete hall sensing for position (FIGS. 16-19), a user can have the option to choose buttons A, C, B, as discussed above. In this embodiment, Hall sensors in motor that is turning the valve can be used to determine rotations and move a predetermined number of degrees, then stop and run the pump. For example, the number of revolutions can be determined by counting ticks on the Hall sensors. In some cases, the position of the hall sensor can be offset by preset number of degrees, such as five degrees, to give time to slow down and start operation. The flowchart for button A is illustrated in FIG. 16, for button B is illustrated in FIG. 17, and for button C is illustrated in FIG. 18.

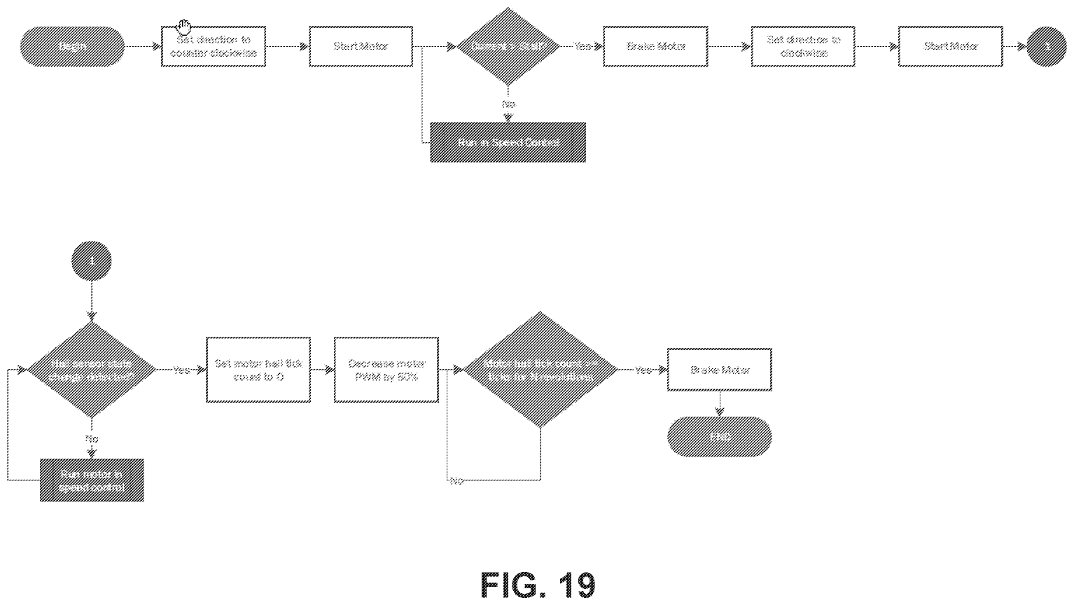

In the flowchart of FIG. 16, the user depresses button A and if the controller determines that the valve is at position A, the controller sends a signal to run the pump. If the controller determines that the valve is not at position A, then the controller determines if the valve is at position C. If yes, the controller sends a signal to set the direction to counterclockwise and start the motor. Once the motor starts, the controller determines if the hall sensor state change is detected. If no, the controller sends a signal to run the motor in speed control until the hall sensor state change is detected. Then, processing continues and the controller sends a signal to set the motor hall tick count to 0 and to decrease the motor pulse width modulation (PWM) by 50%. Pulse width modulation, as it applies to motor control, is a method of delivering energy through a series of pulses rather than a continuously varying (analog) signal. With this increase or decrease in pulse width, the controller is able to regulate energy flow to the motors. Once the motor hall tick count is greater than or equal to the number of ticks for N revolutions, the controller sends a signal to brake the motor and run the pump. If the controller determines that the valve is not at position C, then the controller determines if the valve is at position B. If yes, the controller sends a signal to set the direction to clockwise and start the motor. Once the motor starts, the controller determines if the hall sensor state change is detected. If no, the controller sends a signal to run the motor in speed control until the hall sensor state change is detected. Then, processing continues and the controller sends a signal to determine if another hall sensor state change is detected. If no, the controller sends a signal to run the motor in speed control until the hall sensor state change is detected. Then, processing continues to set the motor hall tick count to 0 and to decrease the motor pulse width modulation (PWM) by 50%. Once the motor hall tick count is greater than or equal to the number of ticks for N revolutions, the controller sends a signal to brake the motor and run the pump. If the controller determines that the valve is not at position C, then the controller determines if the valve is at position B. If the valve is not at any of positions A, B or C, then the valve position is reset, as shown in FIG. 19.

Similar processing can be executed for user selection of position B as for position A described above, as shown in FIG. 17. For example, if the user depresses button B and if the controller determines that the valve is at position A, the controller sends a signal to set the direction to counterclockwise and start the motor. Once the motor starts, the controller determines if the hall sensor state change is detected. If no, the controller sends a signal to run the motor in speed control until the hall sensor state change is detected. Then, processing continues and the controller sends a signal to determine if another hall sensor state change is detected. If no, the controller sends a signal to run the motor in speed control until the hall sensor state change is detected. Then, processing continues to set the motor hall tick count to 0 and to decrease the motor pulse width modulation (PWM) by 50%. Once the motor hall tick count is greater than or equal to the number of ticks for N revolutions, the controller sends signal to brake the motor and run the pump. If the controller determines that the valve is not at position A, then the controller determines if the valve is at position C. If yes, the controller sends a signal to set the direction to clockwise and start the motor. Once the motor starts, the controller determines if the hall sensor state change is detected. If no, the controller sends a signal to run the motor in speed control until the hall sensor state change is detected. Then, processing continues and the controller sends a signal to set the motor hall tick count to 0 and to decrease the motor pulse width modulation (PWM) by 50%. Once the motor hall tick count is greater than or equal to the number of ticks for N revolutions, the controller sends signal to brake the motor and run the pump. If the controller determines that the valve is not at position C, then the controller determines if the valve is at position B. If yes, the controller sends a signal to run the pump. If the valve is not at any of positions A, B or C, then the valve position is reset, as shown in FIG. 19.

Similar processing can be executed for user selection of position C as for position A and B described above, as shown in FIG. 18. For example, if the user depresses button C and if the controller determines that the valve is at position A, the controller sends a signal to set the direction to clockwise and start the motor. Once the motor starts, the controller determines if the hall sensor state change is detected. If no, the controller sends a signal to run the motor in speed control until the hall sensor state change is detected. Then, processing continues to set the motor hall tick count to 0 and to decrease the motor pulse width modulation (PWM) by 50%. Once the motor hall tick count is greater than or equal to the number of ticks for N revolutions, the controller sends signal to brake the motor and run the pump. If the controller determines that the valve is not at position A, then the controller determines if the valve is at position C. If yes, then the controller sends a signal to do nothing. If the controller determines that the valve is not at position C, then the controller determines if the valve is at position B. If yes, the controller sends a signal to set the direction to clockwise and start the motor. Once the motor starts, the controller determines if the hall sensor state change is detected. If no, the controller sends a signal to run the motor in speed control until the hall sensor state change is detected. Then, processing continues and the controller sends a signal to set the motor hall tick count to 0 and to decrease the motor pulse width modulation (PWM) by 50%. Once the motor hall tick count is greater than or equal to the number of ticks for N revolutions, the controller sends signal to brake the motor and run the pump. If the valve is not at any of positions A, B or C, then the valve position is reset, as shown in FIG. 19.

In the flowchart of FIG. 19, if the valve not at one of the positions, then the controller determines the position of the valve. For example, the controller can set the motor to the counterclockwise direction and start the motor. The controller then determines whether the current is greater than the stall current. If no, the motor runs in speed control. If yes, the controller sends a signal to brake the motor, set the direction to clockwise, and start the motor. Then, the controller determines whether the hall sensor state change is detected. If no, the motor runs in speed control. If yes, the controller sends a signal to set the motor hall tick count to 0 and to decrease the motor PWM by 50%. Once the motor hall tick count is greater than or equal to the number of ticks for N revolutions, the controller sends signal to brake the motor and run the pump.

Referring now to BLDC motor control with continuous angular measurements via ZMID position sensor or inductor sensing (FIGS. 20-22), a user can have the option to choose buttons A, C, and B, as discussed above. In this embodiment, ZMID sensors in motor that are turning the valve can be used to determine the number of measured degrees to decrease motor PWM by a certain percentage, then brake the motor and run the pump.

As shown in FIG. 20, in this embodiment, position is determined by output of ZMID sensor. If the user selects position A, processing determines whether valve is at the position A via the ZMID sensor. If yes, then the pump is run. If no, processing determines if valve is at position C. If yes, then direction is set to counterclockwise and processing goes to reset, as shown in FIG. 19. Then, the controller sends a signal to start the motor after processing goes to reset. The controller then determines if the position of the ZMID sensor is offset below 85 degrees. If no, the controller sends a signal to run the motor in speed control. If yes, the controller sends a signal to decrease the motor PWM by 50%. Once the controller then determines if the position of the ZMID sensor is offset below 90 degrees, the controller sends a signal to brake the motor and run the pump. Similar steps can be followed if the valve is not at position C. For example, if the valve is not at position C, the controller then determines if the valve is at the position B via the ZMID sensor. If no, the controller then determines if the position of the ZMID sensor is offset less than or equal to 0 degrees. If the position of the ZMID sensor is offset more than 0 degrees, the controller sends a signal to set the direction to clockwise and processing goes to reset, as shown in FIG. 19. If the valve is either at position B or not at position B, but the controller determines the position of the ZMID sensor is offset less than or equal to 0 degrees, then the controller sends a signal to set the direction to counterclockwise and start the motor. The controller then determines if the position of the ZMID sensor is offset below 85 degrees. If no, the controller sends a signal to run the motor in speed control. If yes, the controller sends a signal to decrease the motor PWM by 50%. Once the controller then determines if the position of the ZMID sensor is offset below 90 degrees, the controller sends a signal to brake the motor and run the pump.

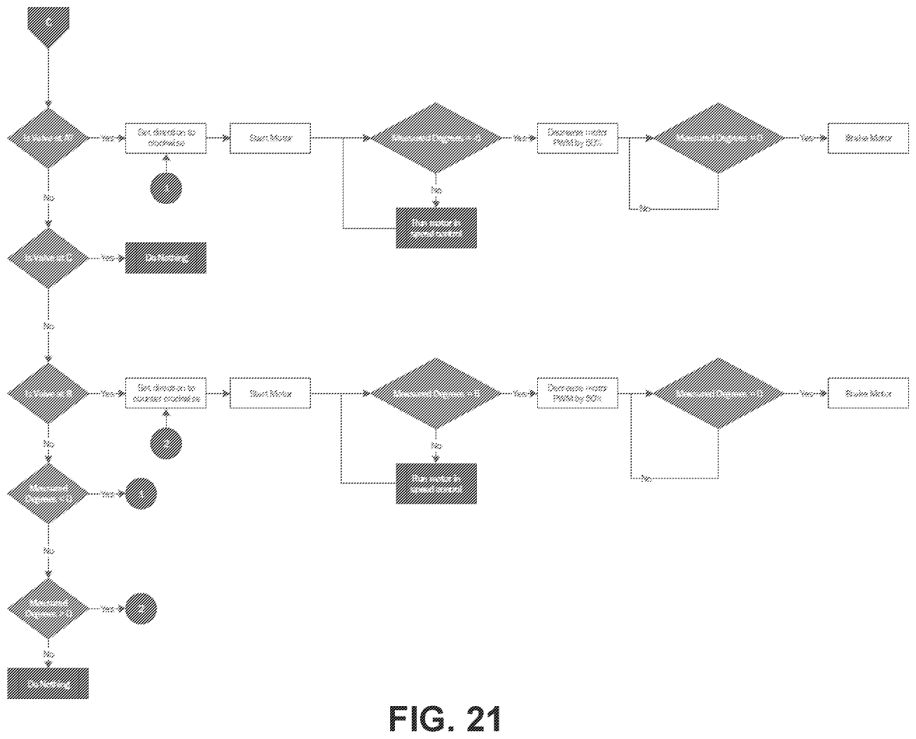

As shown in FIG. 21, in this embodiment, position is determined by output of ZMID sensor. When the user selects position C, processing determines whether valve is at the position A via the ZMID sensor. If yes, then the controller sends a signal to set the direction to clockwise and start the motor. The controller then determines if the position of the ZMID sensor is offset below five degrees. If no, the controller sends a signal to run the motor in speed control. If yes, the controller sends a signal to decrease the motor PWM by 50%. Once the controller determines that the position of the ZMID sensor is not offset in any degree (i.e. the measured degree is zero), the controller sends a signal to brake the motor. If processing determines that the valve is not at position A via the ZMID sensor, the controller then determines if the valve is at position C via the ZMID sensor. If yes, the controller sends a signal to do nothing. If no, the controller then determines if the valve is at position B via the ZMID sensor. If yes, the controller sends a signal to set the direction to counterclockwise and start the motor. The controller then determines if the position of the ZMID sensor is offset above five degrees. If no, the controller sends a signal to run the motor in speed control. If yes, the controller sends a signal to decrease the motor PWM by 50%. Once the controller determines that the position of the ZMID sensor is not offset in any degree (i.e. the measured degree is zero), the controller sends a signal to brake the motor. If the controller determines that the valve is not at position B via the ZMID sensor, the controller then determines if the position of the ZMID sensor is offset any degree below or above zero degrees (i.e. the measured degrees is less than or greater than zero). If the position of the ZMID sensor is offset any degree below zero degrees, the controller sends a signal to set the direction to clockwise and start the motor and follows the processing as described above when the valve is at position A via the ZMID sensor. If the position of the ZMID sensor is offset any degree above zero degrees, the controller sends a signal to set the direction to counterclockwise and start the motor and follows the processing as described above when the valve is at position B via the ZMID sensor. If the position of the ZMID sensor is neither offset any degree below nor above zero degrees and the valve is not at any of the positions A, B, or C, then the controller sends a signal to do nothing.

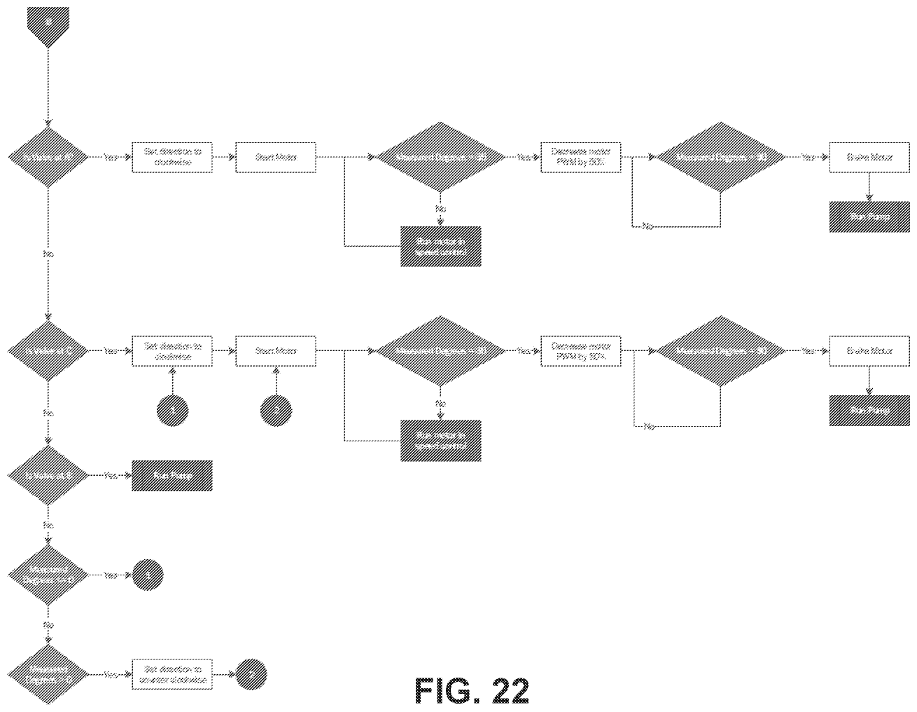

Similar processing can be executed for user selection of position B as for position A and C described above, as shown in FIG. 22. When the user selects position B, processing determines whether valve is at the position A via the ZMID sensor. If yes, then the controller sends a signal to set the direction to clockwise and start the motor. The controller then determines if the position of the ZMID sensor is offset above 85 degrees. If no, the controller sends a signal to run the motor in speed control. If yes, the controller sends a signal to decrease the motor PWM by 50%. Then, the controller determines if the position of the ZMID sensor is offset above 90 degrees. If yes, the controller sends a signal to brake the motor and run the pump. If the valve is not at position A via the ZMID sensor, the controller then determines if the valve is at position C. If yes, the controller sends a signal to set the direction to clockwise and start the motor. Then, the controller determines if the position of the ZMID sensor is offset above 85 degrees. If no, the controller sends a signal to run the motor in speed control. If yes, the controller sends a signal to decrease the motor PWM by 50%. Once the controller determines that the position of the ZMID sensor is offset above 90 degrees, the controller sends a signal to brake the motor and run the pump. If the valve is not at position C via the ZMID sensor, the controller then determines if the valve is at position B. If yes, the controller sends a signal to run the pump. If no, the controller determines if the position of the ZMID sensor is offset any degree above 0 degrees. If no, the controller sends a signal to continue processing described above as if the valve is at position C. If yes, the controller sends a signal to set the direction counter clockwise and continue described above as if the valve is at position C, with processing beginning from the controller sending a signal to start the motor.

Additionally, though not specifically shown and described herein, some embodiments may include a stepper motor and a ZMID sensor.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

Various features and advantages of the disclosure are set forth in the following claims.

1. A directional control valve for a dual action hydraulic pump, the directional control valve comprising:
a valve body comprising four ports;
a rotor positioned within the valve body and comprising a plurality of passages configured to connect and disconnect the ports of the valve body;
a plurality of shear seal discs, each positioned adjacent to one of the plurality of passages;
a sensor;
a plurality of gear trains; and
a motor configured to adjust a position of the rotor, the motor being one of a brushless motor or a stepper motor.

2. The directional control valve of claim 1, wherein the four ports include a pressure port, a first port, a second port, and a tank port.

3. The directional control valve of claim 1, wherein the rotor further comprises a plurality of ports in fluid communication with the ports of the valve body.

4. The directional control valve of claim 3, wherein the rotor is movable between a first position, a middle position, and a second position.

5. The directional control valve of claim 4, wherein the first position corresponds to moving the rotor to the first position from the middle position and aligning the ports in the rotor with the ports in the valve body,
wherein in the first position, the pressure port is in fluid communication with the first port and the second port is in fluid communication with the tank port.

6. The directional control valve of claim 4, wherein the second position corresponds to moving the rotor to the second position from the middle position and aligning the ports in the rotor with the ports in the valve body,
wherein in the second position, the pressure port is in fluid communication with the second port and the first port is in fluid communication with the tank port.

7. The directional control valve of claim 1, wherein the plurality of shear seal discs is configured to be in contact with the rotor for sealing.

8. A method of operating a directional control valve including a valve body, a rotor positioned within the valve body, a plurality of shear seal discs, a sensor, a plurality of gear trains, and a motor configured to adjust a position of the rotor, the method comprising:
activating the valve body with the plurality of gear trains and the motor, the motor coupled to the plurality of gear trains; and
controlling a position of the valve body via at least one of the sensor and the motor, the motor being one of a brushless motor or a stepper motor.

9. The method of claim 8, further comprising:
controlling the position of the rotor with the sensor, wherein the rotor includes a sensor arm coupled to the rotor.

10. The method of claim 8, further comprising:
controlling the position of the valve body in a first configuration, the first configuration including the brushless motor and the plurality of gear trains.

11. The method of claim 10, wherein the plurality of gear trains include a planetary gear set and a worm gear set.

12. The method of claim 10, wherein the sensor includes one of a ZMID sensor or a Hall sensor.

13. The method of claim 8, further comprising:
controlling the position of the valve body in a second configuration, the second configuration including a stepper motor and the plurality of gear trains.

14. The method of claim 13, wherein the plurality of gear trains includes one of a single-stage planetary gear set or a two-stage planetary gear set.

15. A method of determining a valve position of a directional control valve including a valve body, a rotor positioned within the valve body, a sensor, a motor configured to adjust a position of the rotor, and a controller, the method comprising:
depressing one of a plurality of buttons for an user designated valve position;
determining if the valve is at the valve position via the controller; and
sending a signal via the controller to activate the motor, the motor being one of a stepper motor or a brushless motor

16. The method of claim 15, further comprising:
activating the stepper motor to move the valve body a number of steps determined by the stepper motor; and
operating a pump in fluid communication with the directional control valve based on the number of steps.

17. The method of claim 15, further comprising:
determining a number of rotations based on the sensor in the brushless motor, the sensor being a Hall sensor;
moving a predetermined number of degrees based on the number of rotations; and
operating a pump in fluid communication with the directional control valve based on the predetermined number of degrees.

18. The method of claim 17, further comprising:
offsetting a position of the Hall sensor by a preset number of degrees.

19. The method of claim 15, further comprising:
determining a number of measured degrees determined by the sensor in the brushless motor, the sensor being a ZMID sensor;
decreasing a pulse width modulation of the motor by a certain percentage determined by the number of measured degrees; and
operating a pump in fluid communication with the directional control valve determined by the pulse width modulation of the motor.

20. The method of claim 15, further comprising:
resetting the valve position if the valve is not at the user designated valve position.
